(19) United States
(12) Patent Application Publication
(10) Pub. No.: US 2004/0016353 A1
(43) Pub. Date: Jan. 29, 2004

(54) Punching device

(76) Inventor: Bernd Wegter, Nordhorn (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/416,690

(22) PCT Filed: Oct. 20, 2001
(86) PCT No.: PCT/EP01/12150

(30) Foreign Application Priority Data
Nov. 10, 2000 (DE) 200 19 097.0

(51) Int. Cl. B30B 3/04

(52) U.S. Cl. 100/176; 100/161

(57) ABSTRACT

The invention pertains to a device for processing printed matter, in particular, for punching, perforating, grooving, embossing, imprinting, spot-coating or the like. In order to simplify the attachment of the processing tools required for the additional processing, the invention proposes that a carrier be attached to a rotating or flat working element 8. The processing tools can be attached to this carrier such that they can be easily removed again. The size of the processing tools 3 that, for example, are provided with punching lines 4 can be limited to the processing area. The processing tools can be removed and also easily repositioned at any time. A magnetic attachment proved particularly advantageous. For this purpose, the carrier may be realized in the form of a magnetic foil 6.

The invention pertains to a device according to the preamble of claim 1.

In addition to pure punch presses with oscillating tools as known, e.g., from the sheet metal processing industry, there also exist punching devices for the paper processing industry, where punching tools are exclusively used in these punching devices. However, it is also known to provide rollers or cylinders that are intended for printing purposes and which are referred to, for example, as printing cylinders, form cylinders or rubber cylinders with processing tools that extend around these cylinders in a curved fashion. This makes it possible inexpensively to carry out punching, perforating, grooving or embossing processes on the printed or yet-to-be printed paper or cardboard sheets in addition to the printing process, i.e., with the working means that are in any case provided in a printing plant.

Analogous to printing blankets that are placed around the rubber cylinders and clamped thereon, the aforementioned processing tools are also realized in such a way that they can be clamped onto rubber cylinders. Alternatively, it is possible to bond the processing tools onto a cylinder of a printing station in a printing machine, in particular, for larger batch sizes to be punched.

In both instances, it is disadvantageous if processing tools of comparatively large formats are used. The manufacture of these processing tools is very complicated, and consequently expensive, for example, if the complete format of a punching sheet must be etched down except for the punching lines. Such clamped, large-format punching sheets are also very difficult to position, so that corrections for adapting the punching pattern to the sheets to be processed are associated with significant expenditures after the punching sheet is initially clamped in position. Also, expenditures for repositioning and correcting the position of the punching sheets are even greater when the punching sheets are bonded in position.

In addition to punching processes, groove-forming, perforating or embossing processes are also carried out in printing machines as part of the so-called in-line manufacture of printed sheets. These processes practically represent special instances of punching processes and were, until now, carried out with comparable working means.

In an in-line manufacture, imprinting or coating means are also used for realizing additional processing steps in printing machines. In these instances, the alignment of the corresponding tools into the required working position is a known problem that can only be solved with significant mechanical expenditures.

In other known processing machines, flat as well as flat and cylindrical working surfaces are arranged opposite one another. In machines of this type also for processing printed matter and packaging materials, the attachment of the processing tools also represents a known problem. The attachment of the processing tools on flat or curved surfaces does not differ in principle from the purely rotative processing method in this case. For example, the above-described problems also arise in a rotative processing tool that cooperates with a flat counter surface. Only the special requirements with respect to the curvature are eliminated with flat processing tools. The relationship between the high expenditure for a full-surface processing tool and, if applicable, a small actual working surface is identical to the previously described circumstances.

Consequently, the invention is based on the objective of improving a device of this type in such a way that it can also be inexpensively used for small lot sizes and not only allows a rapid and simple handling of the processing tools, e.g., punching sheets or printing forms, during their attachment and removal, but also, in particular, during a possibly required repositioning of the processing tool.

This objective is realized with a device with the characteristics of claim 1.

In other words, the invention proposes to use processing tools that do not extend completely around the cylinder periphery, but rather small and inexpensive processing tools, e.g., punching sheets, which are fixed by adhesion to the cylinder and whose position can also be easily corrected after they are fixed on the cylinder. A separable adhesive connection surprisingly suffices for fixing the processing tools in position in order to carry out punching processes in the paper and cardboard processing industry and to protect the processing tools from shifting on the cylinder.

Here, the term “adhesion” refers to a connection between the processing tool and the cylinder that makes it possible to fix the processing tool on the cylinder without additional fastening means, e.g., screws, strong adhesives or the like, and subsequently to remove the processing tool from the cylinder without the assistance of tools, solvents or the like. Such an “adhesion” is, for example, known from the field of office administration in the form of so-called “adhesive notes.” Besides a weak adhesive force, the desired adhesion may also be achieved in other ways. For example, since punching sheets frequently consist of a ferromagnetic sheet metal, it is possible to provide the cylinder with magnets or a magnetic foil.

The adhesive arrangement may either be located on the cylinder, for example, in the form of a weak adhesive or magnetic coating, or on the processing tools, for example, in the form of a weak adhesive or magnetic coating.

However, it would also be conceivable to use an intermediate element in the form of a so-called carrier between the cylinder and the processing tool. For example, this carrier may be realized similarly to a printing blanket such that it can be conventionally clamped onto existing cylinders. This carrier makes it possible adhesively to fix processing tools. Consequently, it is possible reliably to prevent undesirable changes to the surface of the cylinder, e.g., scrapes or soiling caused by the handling of the processing tools, wherein said surface changes only occur on the carrier that can be replaced relatively inexpensively.

The carrier may merely serve to protect the cylinder and for the fixing of processing tools prepared with an adhesive. Alternatively, the carrier may also be realized with the adhesive.

Such a carrier may consist of a textile material that has a weak adhesive or magnetic effect on its outer surface; for example, the carrier is coated with a weakly adhesive layer or contains magnetic strips that are woven into the textile material. Alternately, the carrier may be provided with a magnetic foil or individual magnets on its surface.

In instances in which the punching sheets can be magnetically fixed on the carrier, specifically, the carrier may contain a ferromagnetic layer or a substructure of a ferromagnetic sheet metal, where the carrier may also contain a sheet metal foil that can be very easily bent to conform to the cylinder. This results in a so-called reversing effect that intensifies the magnetic force on the surface of the magnet that opposes the substructure such that a reliable retention of the punching sheets is also achieved if a comparatively thin and weak magnetic layer is used.

When using magnetic foils for the carrier of processing tools, it is advantageous to use magnetic foils with a particularly advantageous pole pitch. Magnetic foils of this type are generally known. A particularly advantageous adhesiveness is achieved, for example, when using magnetic foils with a thickness of approximately 1 mm. In this case, an optimized relation is achieved between the magnetic force that can be realized and the assignment of the processing tool to the carrier with respect to the kinematics and the mechanics of the processing method, where said assignment is changed due to the thickness of the magnetic foil.

It is advantageous if the surface of either the cylinder or the carrier is provided with auxiliary lines, e.g., like those of graph paper from the field of technical drawing. This makes it possible to achieve a particularly simple and correct positioning of the processing tools, where the checking and correction of the positioned processing tool are simplified.

If a carrier that is fixed on the cylinder, for example, a conventional rubber cylinder, is provided for the processing tools, the carrier may be fixed on the cylinder by means of clamping rails as they are conventionally used in the printing industry for printing blankets. The connection between a magnetic foil or a weakly adhesive layer and the substructure, i.e., a plate or a foil consisting of textile, metallic or plastic materials, can be realized by means of bonding, fusion, or a pin connection in order to ensure that the adhesive layer is reliably fixed on this substructure of the carrier.

If the carrier has corresponding stability, it is not only possible to use the carrier on cylindrical working means, but also on flat working means, e.g., flatbed working machines. In this case, the adhesiveness of the carrier on ferromagnetic substructures can be advantageously used. The carrier essentially holds itself and the processing tools on the working surface of the working machine. However, this does not eliminate the need to clamp the carrier in position because the exact position or positioning of the processing tool including the carrier must be ensured.

Punching, perforating, groove-forming, embossing, imprinting or spot-coating plates may be considered as processing tools. The processing tools may also be realized in linear form or any other form that is adapted to the desired working region.

A particular advantage of the device according to the invention is that arbitrary processing tools can be very easily exchanged in the processing machines without having to remove the carrier, which serves for adhesively fixing the processing tools, from the given machine. It is even possible to reposition the processing tool within the processing machine.

Embodiments of the invention are described in greater detail below with reference to the purely schematic drawing.

It shows:

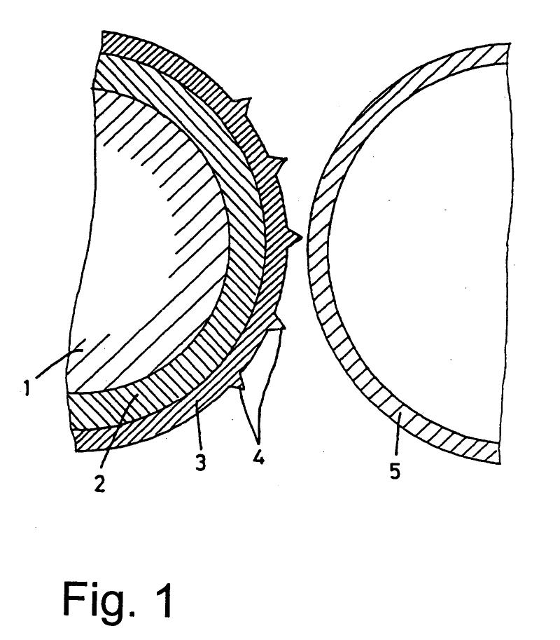

FIG. 1, the packing in a printing machine;

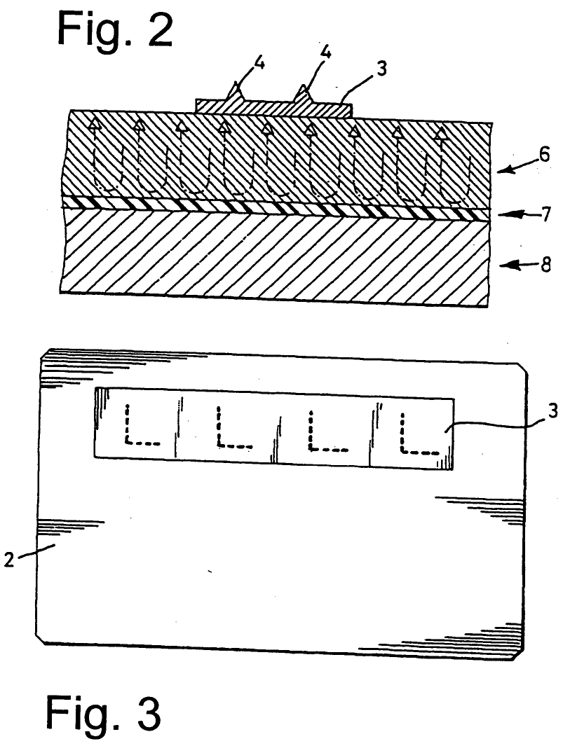

FIG. 2, a cross section through a carrier with a punching sheet;

FIG. 3, a top view of the carrier and a punching sheet, and

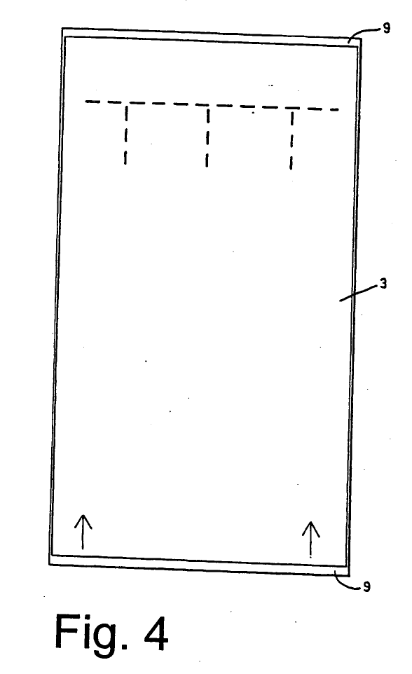

FIG. 4, a punching sheet according to the known state of the art.

### DETAILED DESCRIPTION OF THE INVENTION

In FIG. 1, the reference symbol 1 identifies a roller-shaped cylinder that usually is already provided in a printing machine, particularly an offset printing machine, and that is referred to, for example, as a so-called rubber cylinder. A carrier 2 is clamped onto the cylinder 1 in the same way that printing blankets are clamped to rubber cylinders. The carrier 2 contains a punching sheet 3 that is provided with elevations 4, where several continuously arranged elevations 4 of this type form so-called punching lines.

A paper or cardboard sheet to be punched can be inserted between the cylinder 1 and a counter-pressure cylinder 5, where the peaks of the elevations 4 extend into the vicinity of the surface of the counter-pressure cylinder 5 such that the paper or cardboard sheet inserted between the cylinder 1 and the counter-pressure cylinder 5 is cut or perforated at the corresponding locations.

FIG. 2 shows the design of the carrier 2; the punching sheet 3 is held by a magnetic foil 6. This magnetic foil 6 forms the upper or outer layer of the carrier 2 and ensures the required adhesiveness. The magnetic foil is bonded onto a substructure 8 of the carrier 2 by means of an adhesive layer 7, wherein the substructure 8 consists of a ferromagnetic layer in the form of a steel sheet or a steel foil. The steel sheet or the steel foil, as well as the magnetic foil 6, can be bent in such a way that the entire carrier 2 can be placed around the cylinder 1 and conventionally fixed to the cylinder 1. This may be realized, for example, with the aid of corresponding clamping rails.

The ferromagnetic substructure 8 of the carrier 2 causes a reversing effect within the magnetic foil 6 which is indicated by the curved arrows in FIG. 2. This means that a particularly strong adhesive force is generated on the outer surface of the magnetic foil 6, and that the punching sheets 3 can quite reliably be fixed in position. In addition, the punching sheet 3 can be very easily removed from the carrier 2 because it is not rigidly connected to the carrier 2, e.g., by means of bonding or a screw connection. On the contrary, the punching sheet is merely adhered to the carrier 2. This means that a very simple, continuous and sensitive repositioning of the punching sheet 3 can be realized in order to correct its position. It is also possible to arrange the punching sheets 3 differently or to use differently designed punching sheets 3 on the cylinder 1. This allows an inexpensive, fast and flexible retooling process such that smaller lot sizes can also be economically processed.

FIG. 3 shows a top view of a carrier 2 with an adhered punching sheet 3. One can clearly ascertain that the dimensions of the punching sheet 3 can be chosen very small in relation to the size of the carrier 2. Thus, the complicated processing steps for manufacturing the punching sheet 3, as well as the cost for manufacturing the punching sheet 3, can be significantly reduced in comparison with a punching sheet that conventionally extends over the entire periphery of the cylinder and has approximately the size of the carrier 2.

The invention, in contrast, proposes only to arrange the carrier that is used again and again over the entire periphery of the cylinder such that the corresponding processing tools only need be provided in the regions where punching lines are required. These processing tools may have a correspondingly small and inexpensive design. FIG. 3 shows such a punching sheet 3 with several punching lines of respectively L-shaped configuration.

A punching process merely represents one possible processing step for the in-line manufacture of paper or cardboard products in a printing machine. It would also be conceivable to use perforating, groove-forming or embossing tools instead of punching tools. Processing tools of this type frequently cover only a small surface. For example, perforating or groove-forming tools are usually realized in linear fashion. Embossing tools have a relatively small size and may be limited to a local embossing pattern, e.g., a coat of arms. Most of these processing tools are manufactured from ferromagnetic material, as is also the case with punching tools. Therefore, they can be adhesively and separably attached to a carrier formed from a metal foil directly, i.e., without auxiliary means. Processing tools of the aforementioned type which have a corresponding flexibility may also be provided with a weakly adhesive coating on the back side and attached adhesively and separably to the carrier in this way. Conversely, the carrier may be provided with a surface that is weakly adhesive compared with the back side of the processing tools. The attachment and alignment of the corresponding processing tools can be performed very easily, also within the working machine used.

It is also possible to carry out imprinting or special coating processes at certain locations within a printing machine. One example of this process is so-called spot-coating. Here, an application device for coating fluids or printing inks is assigned to the cylinder that serves for mounting the processing tools. This application device conventionally cooperates with the respective surface of a processing tool on the corresponding cylinder. The surface of the processing tool may be realized in the form of a rubber blanket, a printing plate or a plastic layer on a foil-like carrier layer. In this case, the processing tool may also be provided with a compressible layer of an elastic, cellular or porous material between the carrier layer and the surface. This intermediate layer may have damping properties with respect to the stresses occurring during the process. As described above, corresponding processing tools for applying localized printing patterns, individual print images or surface coatings of limited surface area may be provided. The back side of the processing tools may be realized in a weakly adhesive or ferromagnetic fashion in this case in order to attach the processing tools adhesively and separably. In a ferromagnetic variation, such a processing tool for printing or coating processes can be arbitrarily positioned in an easily separable fashion on a carrier or cylinder provided with a magnetic foil. The attachment and the alignment of the corresponding printing or coating tools can also be easily realized within the working machine used.

The described attachment of processing tools for processing paper or cardboard products is not limited to cylindrical working elements such as cylinders. These mounting methods may be analogously used in working machines with flat working elements. In these so-called flatbed machines, the working surface, as initially mentioned, is subjected to an oscillating vertical movement relative to the paper or cardboard material to be processed. The processing tools may also be adhesively and separably attached to a carrier in this case. This carrier is fixed on the working surface of the working machine in a comparable fashion. However, the carrier is not bent in this case, but rather flatly clamped onto the working surface. The processing tools can also be very easily attached, positioned and removed again in this case without having to exchange the carrier and without risking damage to its surface or the surface of the working element of the working machine. However, the carrier still must be clamped in position because the processing tool including the carrier must be secured in the respective position.

It is possible to use different variations of flat working surfaces. As described above, the flat working surface may be provided on the processing tool or on the counter surface. Thus, there are various production methods that may be used for the above-described processes. Since the processing tool can be used on cylindrical and flat carriers, the following combinations are possible:

cylindrical processing tool with cylindrical counter surface

cylindrical processing tool with flat counter surface

flat processing tool with cylindrical counter surface or

flat processing tools with flat counter surface.

The required devices are discussed in the above-described arrangements.

It must be noted that the relative movements of the working surface and the counter surface will vary in the above-described combinations. For example, with the combination of a flat surface and a cylindrical surface, the flat surface is moved back and forth in an oscillating fashion and thus brought in contact with the rotating cylindrical counter surface. The work stroke may only take place in one direction such that the sheet material to be processed is inserted on one side and removed on the other side of the working machine.

The device according to the invention consequently allows a wide range of processing options for different applications.

The adhesion of the processing tools on the carrier can be improved by increasing the surface that adheres to the carrier in relation to the working surface. In processing tools with a non-ferromagnetic working surface, in particular, it would be conceivable to provide a thin and, if so required, large-surface substructure of a ferromagnetic material. This arrangement allows the realization of sliding transitions between the adhesive surface and the working surface of the processing tool. Consequently, various processing steps, e.g., imprinting or coating steps, can be improved.

FIG. 4, in contrast, shows a punching sheet 3 according to the state of the art with punching lines in an approximately E-shaped configuration. This punching sheet 3 contains clamping rails 9 on both end surfaces, where said clamping rails are realized conventionally and are thus only indicated schematically. In order to produce the punching lines, punching sheets 3 of this type are usually etched down over nearly the entire surface until only the punching lines remain. Thus, the work effort increases with the size of the punching sheet 3 and in relation to the actually effective surface area of the punching sheet 3 around the punching lines.

What is claimed is:

1. Device for punching, grooving, perforating, embossing, imprinting and coating paper materials and the like, with a roller-shaped cylinder, on the periphery of which at least one processing tool is arranged, wherein the processing tool contains a working surface that extends [text missing in original] an additional cylinder that is arranged opposite of and assigned to the above-mentioned cylinder, and wherein the working surface is arranged flat or [text missing in original], characterized by the fact that the processing tool (3) is adhesively and separably fixed on the cylinder (1).

2. Device according to claim 1, characterized by a carrier (2) that can be clamped onto the cylinder (1) and carries the processing tool (3).

3. Device according to claim 1 or 2, characterized by the fact that the underside of the processing tool (3) which is directed toward the cylinder (1) is realized adhesively, e.g., provided with an adhesive coating.

4. Device according to claim 1 or 2, characterized by the fact that the surface of the cylinder (1) and/or the carrier (2) is realized adhesively, e.g., provided with an adhesive coating.

5. Device according to one of claims 1-4, characterized by the fact that the adhesiveness is achieved with a weak adhesive.

6. Device according to one of claims 1-4, characterized by the fact that the adhesiveness is achieved with the aid of magnets.

7. Device according to claim 6, characterized by the fact that the adhesiveness is achieved with the aid of a magnetic foil (6).

8. Device according to claims 2 and 6, characterized by the fact that the carrier (2) contains magnets or a magnetic layer, as well as a substructure (8) of ferromagnetic material, e.g., steel, which is situated underneath the magnets or the magnetic layer.

9. Device according to claim 8, characterized by the fact that the substructure (8) is realized in the form of a sheet metal plate or a sheet metal foil.

10. Device for punching, grooving, perforating or embossing paper materials and the like, with a flat working element, on the flat working surface of which at least one processing tool is arranged, wherein the processing tool contains a working surface that is arranged opposite to another flat working surface, characterized by the fact that the processing tool (3) is adhesively and separably fixed on the flat working surface of the working element.

11. Device for punching, grooving, perforating or embossing paper materials and the like, with a flat working element, on the cylindrical working surface of which at least one processing tool is arranged, wherein the processing tool contains a working surface that is arranged opposite to a flat working surface, characterized by the fact that the processing tool (3) is adhesively and separably fixed on the cylindrical working surface of the working element.

12. Device for punching, grooving, perforating or embossing paper materials and the like, with a flat working element, on the flat working surface of which at least one processing tool is arranged, wherein the processing tool contains a working surface that is arranged opposite to a cylindrical working surface, characterized by the fact that the processing tool (3) is adhesively and separably fixed on the flat working surface of the working element.

13. Device according to claims 10, 11 or 12, characterized by a carrier (2) that can be clamped onto the flat working element and carries the processing tool (3).

14. Device according to claim 10, 11 or 12, characterized by the fact that the underside of the processing tool (3) which is directed toward the flat working element is realized adhesively, e.g., provided with an adhesive coating.

15. Device according to claim 10, 11 or 12, characterized by the fact that the surface of the flat working element and/or the carrier (2) is realized adhesively, e.g., provided with an adhesive coating.

16. Device according to one of claims 10-15, characterized by the fact that the adhesiveness is achieved with a weak adhesive.

17. Device according to one of claims 10-15, characterized by the fact that the adhesiveness is achieved with the aid of magnets.

18. Device according to claim 17, characterized by the fact that the adhesiveness is achieved with the aid of a magnetic foil (6).

19. Device according to claims 13 and 18, characterized by the fact that the carrier (2) contains magnets or a magnetic layer, as well as a substructure (8) of ferromagnetic material, e.g., steel, which is located underneath the magnets or the magnetic layer.

20. Device according to claim 19, characterized by the fact that the substructure (8) is realized in the form of a sheet metal plate or a sheet metal foil.

21. Device according to one of the preceding claims, characterized by the fact that the processing tool consists of a punching, perforating, groove-forming or embossing tool of ferromagnetic material.

22. Device according to one of the preceding claims, characterized by the fact that the processing tool consists of a tool that is realized similarly to a printing plate and serves for producing an imprint or for applying a localized coating, and by the fact that the rear side of the tool contains a layer consisting of a ferromagnetic material.

23. Device according to claim 22, characterized by the fact that the tool is attached to a ferromagnetic foil or a ferromagnetic sheet metal.
